(19) United States
(12) Patent Application Publication
(10) Pub. No.: US 2015/0355393 A1
(43) Pub. Date: Dec. 10, 2015

(54) CUBE CORNER REFLECTOR AND METHODS THEREOF

(71) Applicant: ORAFOL AMERICAS INC., Avon, CT (US)

(72) Inventors: Xiao Jing LU, Bloomfield, CT (US); Steven SCOTT, Avon, CT (US)

(21) Appl. No.: 14/759,785

(22) PCT Filed: Feb. 11, 2014
(86) PCT No.: PCT/US14/15713

§ 371 Date: Jul. 8, 2015

Related U.S. Application Data
(60) Provisional application No. 61/763,161, filed on Feb. 11, 2013.

(51) Int. Cl. G02B 5/124; B29D 11/00

(52) U.S. Cl. CPC G02B 5/124; B29D 11/0074

(57) ABSTRACT

Molds and methods for forming molds used to make retroreflective articles are disclosed. The mold includes a plurality of shims joined together wherein each of the shims comprises a plurality of alternating cube corners. Each of the cube corners includes three facets each comprising a planar surface, four exterior sides, and three interior edges. The three interior edges meet at an apex, wherein each of the cube corners shares, with an adjacent one of the cube corners, at least one exterior side intersected by a respective one of the interior edges of each of the adjacent cube corners. A retroreflective article is formed using the mold and the retroreflective article includes goemetric structures corresponding to the cube corners of the plurality of shims of the mold.

This application claims the benefit of U.S. Provisional Application No. 61/763,161 filed Feb. 11, 2013, which is hereby incorporated by reference in its entirety.

### FIELD

This technology generally relates to retroreflective materials and, more particularly, to methods for forming cube corner retroreflective sheeting and devices thereof.

### BACKGROUND

Retroreflective materials are characterized by the ability to redirect light incident on the material back toward the originating light source. This property has led to the widespread use of retroreflective sheeting for a variety of traffic and personal safety uses. Retroreflective sheeting is commonly employed in a variety of articles such as road signs, barricades, license plates, pavement markers, and marking tape, for example.

One common type of retroreflector is provided by a surface of full cube corners, or microprisms. A full cube corner may be best suited for applications in which an angle of entrance, or an angle of incident light, is between 0°-30°. In the 0°-30° angle of incident light range, the entire inner cube surface may behave as a retroreflector, where the entire aperture may be regarded as a retroreflective area and substantially all of the incident light will be retro-reflected by three internal reflections of facets. The cube corners may be formed, in one method, by a mold having a surface with the microstructure of the desired shape. This method utilizes a number of plates, or shims, stacked together. A diamond cutting tool can than be used to form a set of grooves on the top surface of the shims.

However, rectangular shaped and other symmetric cube corner retroreflectors may have limited retroreflective properties and can be difficult to manufacture due in part to a relatively high aspect ratio.

### SUMMARY

A mold for forming a retroreflective article includes a plurality of cube corners. Each of the cube corners includes three facets each having a planar surface, four exterior sides, and three interior edges. The three interior edges meet at an apex. Each of the cube corners shares, with an adjacent one of the cube corners, at least one exterior side including two side portions intersected by a respective one of the interior edges of each of the adjacent cube corners.

A method for making a mold for forming a retroreflective article includes cutting, with a first diamond cutting tool of a diamond cutting machine, a plurality of first v-shaped grooves in a shim held by a fixture in a first rotated position. The first v-shaped grooves have a pitch, a first width, and a first depth. The tool is disposed at a first diamond angle for the cutting of the first v-shaped grooves and the first v-shaped grooves form at least a portion of a first facet in each of a plurality of cube corners. A plurality of scond v-shaped grooves in a shim held by a fixture in a second rotated position are cut with a second diamond cutting tool of the diamond cutting machine. The second v-shaped grooves have the pitch, a second width, and a second depth. The tool is disposed at a second diamond angle for the cutting of the second v-shaped grooves and the second v-shaped grooves form at least a portion of a second facet in each of the plurality of cube corners. A plurality of third v-shaped grooves in a shim held by a fixture in a third rotated position are cut with a third diamond cutting tool of the diamond cutting machine. The third v-shaped grooves have the pitch, a third width, and a third depth. The tool is disposed at a third diamond angle for the cutting of the third v-shaped grooves and the third v-shaped grooves form at least a portion of a third facet in each of the plurality of cube corners. The cutting steps are repeated for a plurality of shims and the shims are joined together to form the mold.

A method for forming a retroreflective article includes providing a mold comprising a plurality of shims joined together. Each of the shims includes a plurality of alternating cube corners and each of the cube corners includes three facets. Each of the facets includes a planar surface, four exterior sides, and three interior edges, the three interior edges meeting at an apex. Each of the cube corners shares, with an adjacent one of the cube corners, at least one exterior side intersected by a respective one of the interior edges of each of the adjacent cube corners. The method further includes forming a retroreflective article using the mold, the retroreflective article including geometric structures corresponding to the cube corners of the plurality of shims of the mold.

A retroreflective article includes a plurality of cube corners. Each of the cube corners includes three facets each having a planar surface, four exterior sides, and three interior edges. The three interior edges meet at an apex. Each of the cube corners shares, with an adjacent one of the cube corners, at least one exterior side including two side portions intersected by a respective one of the interior edges of each of the adjacent cube corners.

With this technology, a retroreflective sheet having increased performance and retroreflective output as compared to a retroreflective sheet having rectangular geometric features can be made from a mold. The retroreflective sheet formed using the mold of this technology advantageously exhibits symmetry in both vertical and horizontal directions and in both 45 degree and 135 degree directions. The retroreflective sheet also has a lower aspect and is therefore easier to manufacture than a retroreflective sheet having rectangular geometric features.

### BRIEF DESCRIPTION OF THE DRAWINGS

FIG. 1 is a flowchart of an exemplary method for forming a plurality of shims, a mold from the plurality of shims, and a retroreflective sheet using the mold;

FIG. 2A is a side view of a first exemplary shim before a first cut of v-shaped grooves;

FIG. 2B is a top view of the first exemplary shim held by a fixture before the first cut of v-shaped grooves;

FIG. 3A is a side view of the first exemplary shim after the first cut of v-shaped grooves;

FIG. 3B is a top view of the first exemplary shim after the first cut of v-shaped grooves;

FIG. 4 is a top plan view of the first exemplary shim after the first cut of v-shaped grooves;

FIG. 5A is a side plan view of the first exemplary shim after the first cut of v-shaped grooves;

FIG. 5B is a top view of the first exemplary shim after the first cut of v-shaped grooves;

FIG. 6A is a side view of the first exemplary shim before a second cut of v-shaped grooves;

FIG. 6B is a top view of the first exemplary shim held by the fixture before the second cut of v-shaped grooves;

FIG. 7A is another side view of the first exemplary shim before the second cut of v-shaped grooves;

FIG. 7B is another top view of the first exemplary shim before the second cut of v-shaped grooves;

FIG. 8A is a front view of the first exemplary shim after the second cut of v-shaped grooves;

FIG. 8B is a side view of the first exemplary shim after the second cut of v-shaped grooves;

FIG. 9 is a top view of the first exemplary shim after the second cut of v-shaped grooves;

FIG. 10A is another side view of the first exemplary shim after the second cut of v-shaped grooves;

FIG. 10B is another top view of the first exemplary shim after the second cut of v-shaped grooves;

FIG. 11A is a side view of the first exemplary shim before a third cut of v-shaped grooves;

FIG. 11B is a top view of the first exemplary shim held by the fixture before the third cut of v-shaped grooves;

FIG. 12A is a top view of the first exemplary shim before the third cut of v-shaped grooves;

FIG. 12B is a side view of the first exemplary shim before the third cut of v-shaped grooves;

FIG. 13A is a front view of the first exemplary shim after the third cut of v-shaped grooves;

FIG. 13B is a side view of the first exemplary shim after the third cut of v-shaped grooves;

FIG. 14 is a top view of the first exemplary shim after the third cut of v-shaped grooves;

FIG. 15A is another side view of the first exemplary shim after the third cut of v-shaped grooves;

FIG. 15B is another top view of the first exemplary shim after the third cut of v-shaped grooves;

FIG. 16 is a plan view of three square cube corners of a second exemplary shim;

FIG. 17A is a top view of a portion of the second exemplary shim including three square cube corners;

FIG. 17B is a first perspective view of a portion of the second exemplary shim including three square cube corners;

FIG. 17C is a second perspective view of a portion of the second exemplary shim including three square cube corners;

FIG. 18A is a top view of a portion of the second exemplary shim including two cube corners;

FIG. 18B is a first perspective view of a portion of the second exemplary shim including two cube corners;

FIG. 18C is a second perspective view of a portion of the second exemplary shim including two cube corners;

FIG. 19A is a top view of a third exemplary shim;

FIG. 19B is a perspective view of the third exemplary shim;

FIG. 20 is a top plan view of a plurality of the shims each corresponding to the third exemplary shim joined together to form a basic mold;

FIG. 21 is a perspective view of the basic mold of FIG. 20;

FIG. 22 is a top view of a portion of a fourth exemplary shim including three rhombus cube corners;

FIG. 23A is a top view of a portion of the fourth exemplary shim including three rhombus cube corners;

FIG. 23B is first perspective view of a portion of the fourth exemplary shim including three rhombus cube corners;

FIG. 23C is a second perspective view of a portion of the fourth exemplary shim including three rhombus cube corners;

FIG. 24A is a top view of a portion of the fourth exemplary shim including two rhombus cube corners;

FIG. 24B is a first perspective view of a portion of the fourth exemplary shim including two rhombus cube corners;

FIG. 24C a second perspective view of a portion of the fourth exemplary shim including two rhombus cube corners;

FIG. 25A is a top view of a fifth exemplary shim;

FIG. 25B is a perspective view of the fifth exemplary shim;

FIG. 26 is a top plan view of a plurality of shims each corresponding to the fifth exemplary shim joined together to form a basic mold;

FIG. 27 is a perspective view of the basic mold of FIG. 26;

FIG. 28 is a top plan view of an exemplary retroreflective article; and

FIG. 29 is a perspective view of the retroreflective article of FIG. 28.

### DETAILED DESCRIPTION

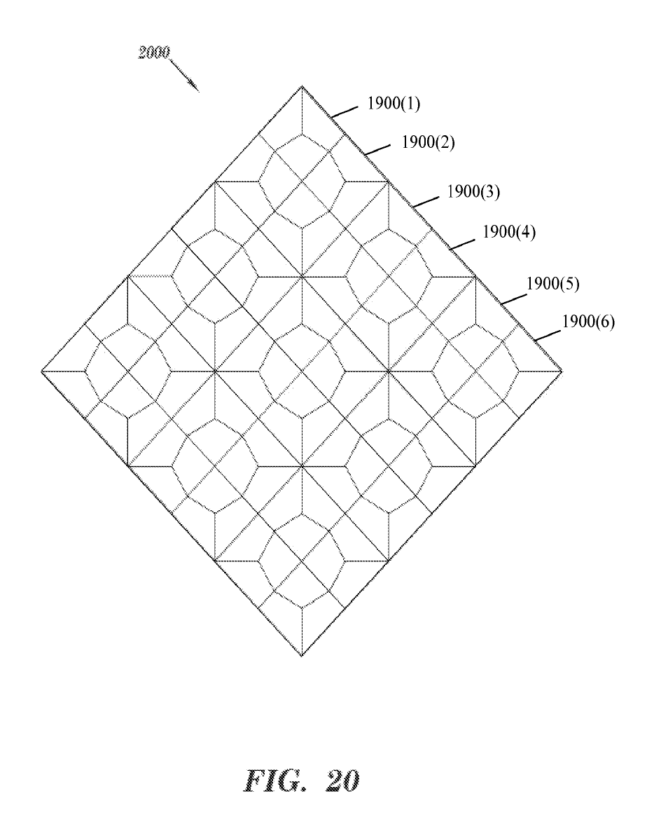

Exemplary molds 2000 and 2600 used to generate a retroreflective sheet 2800 are illustrated in FIGS. 20-21 and 26-27. The molds 2000 and 2600 include a plurality of shims 1900(1)-(6) and 2500(1)-(6), respectively, joined together, although the sheet can comprise other types and numbers of other elements in other configurations. This technology provides a number of advantages including providing a mold configured to produce a retroreflective sheet that has increased performance and retroreflective output as compared to a retroreflective sheet having rectangular geometric feature

Each of the shims 1900(1)-(6) and 2500(1)-(6) joined together to form the mold 2000 and 2600 includes a plurality of v-shaped grooves that together define a plurality of cube corners. In some examples, the plurality of v-shaped grooves includes three sets of v-shaped grooves, one v-shaped groove from each set defining one of the cube corners of the shim 1900 and 2500. The cube corners each have three facets including a planar surface, four exterior sides, and three interior edges, with the three interior edges meeting at an apex. While a shim 1900 and 2600 can include any number of cube corners, a typical shim 1900 and 2600 will have only one row (or column) of cube corners. In an exemplary shim 1900 and 2600, each of the cube corners shares, with an adjacent one of the cube corners, at least one exterior side including two side portions intersected by a respective interior edge of each of the adjacent cube corners.

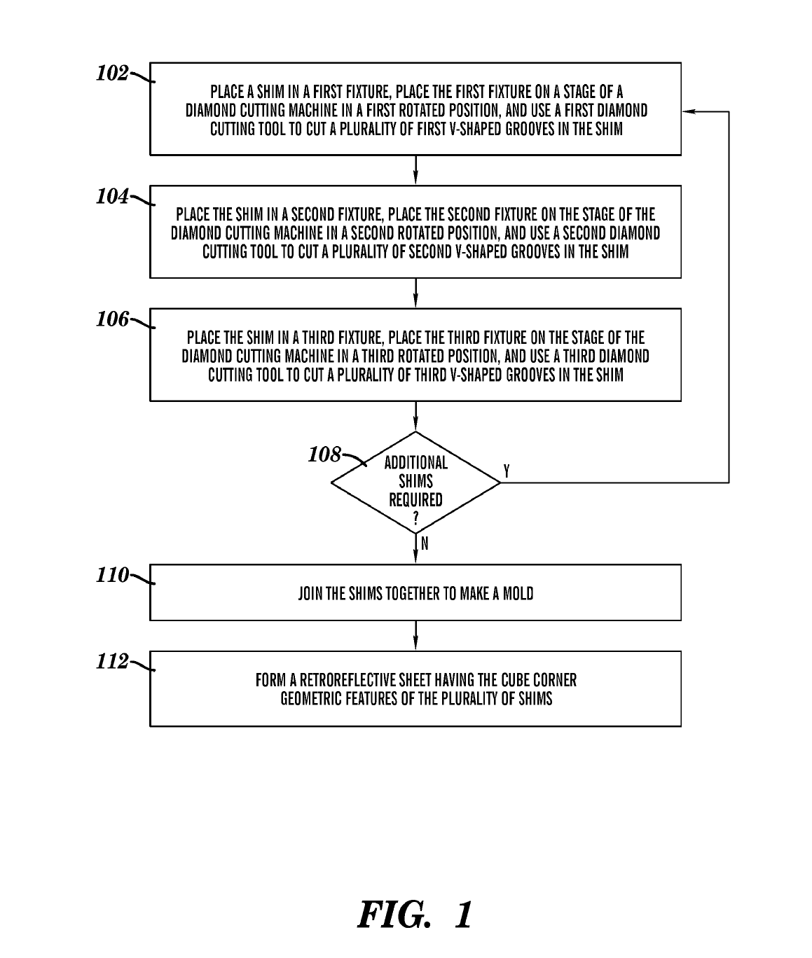

Referring to FIGS. 1-29, a method for forming a mold from a plurality of shims, the mold used to generate a retroreflective article, such as a retroreflective sheet, will now be illustrated and described. Referring to FIGS. 1-5, in step 102, a shim 200 is placed in a first fixture on a stage of a diamond cutting machine and held in place in a first rotated position. A first diamond cutting tool 202 of the diamond cutting machine is used to cut a plurality of first v-shaped grooves. The cut by the diamond cutting tool can be a right edge cut, for example. The shim 200 can have a thickness 204 ranging from about 0.0040 inches to about 0.0080 inches, and other thicknesses can also be used. The shim 200 can have a length ranging from about 1 inch to about 10 inches, and a height ranging from about 0.40 inches to about 5 inches, and other lengths and heights can also be used.

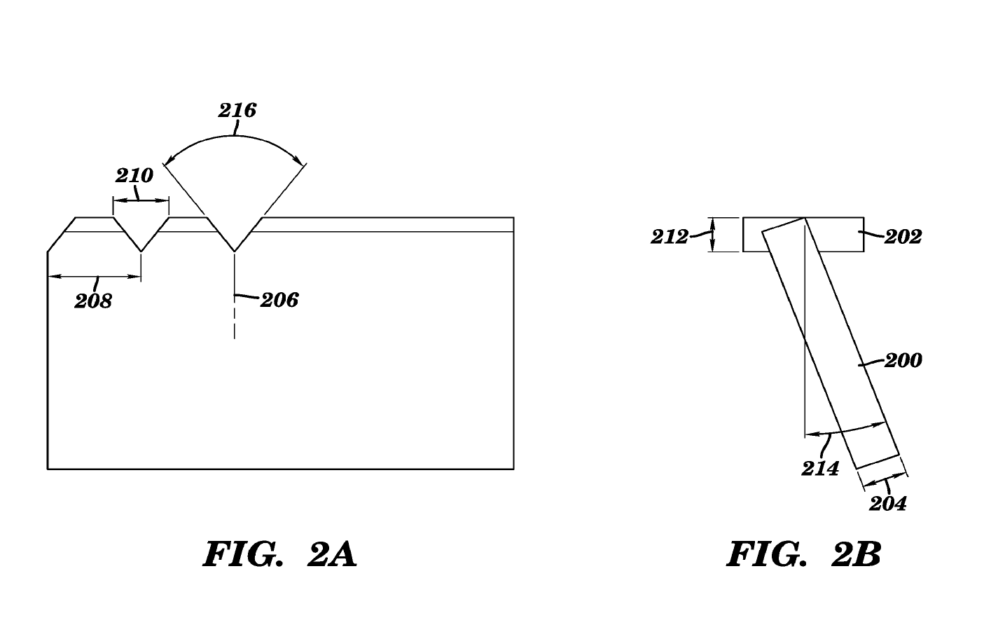

Each of the first v-shaped grooves are cut at points spaced apart and beginning from a starting point 206. The starting point 206 for the first set of v-shaped grooves shown in FIGS. 2-5 is about a thickness 204 of the shim 200 from the starting point 206 for the second and third set of v-shaped grooves. In one example, the starting point for the second and third v-shaped grooves is defined at the longitudinal center of the shim 200, although other starting points for the second and third v-shaped grooves can also be used. Accordingly, the starting point 206 for the first set of v-shaped grooves is a thickness of the shim 200 from the center of the shim 200, left and/or right, although other starting points for any of the sets of v-shaped grooves discussed below can also be used. Additionally, in one example, the cut path for the sets of v-shaped grooves is perpendicular to the longitudinal direction of the shim 200 and parallel to the stage surface of the diamond cutting machine, although other cut paths can also be used.

The first set of v-shaped grooves have a pitch 208, a first width, and a first depth 212. In one example, the pitch 208 is twice the thickness 204 of the shim 200, although other cut pitches can also be used. The first width can be between about 0.005 inches and about 0.01 inches and the first depth 212 can be between about 0.003 and 0.0075 inches, and other widths and depths can also be used. The shim 200 is held in place by the fixture at a first rotated position having an incline angle 214 which can be within a range of about 15 degrees to about 25 degrees. The diamond cutting tool 202 is disposed at a first diamond angle 216 which can be within a range of about 65 degrees to about 87 degrees. Each of the first v-shaped grooves forms at least a portion of a first facet or planar surface in each of two adjacent cube corners of a plurality of cube corners to be cut into the shim 200, as described and illustrated below.

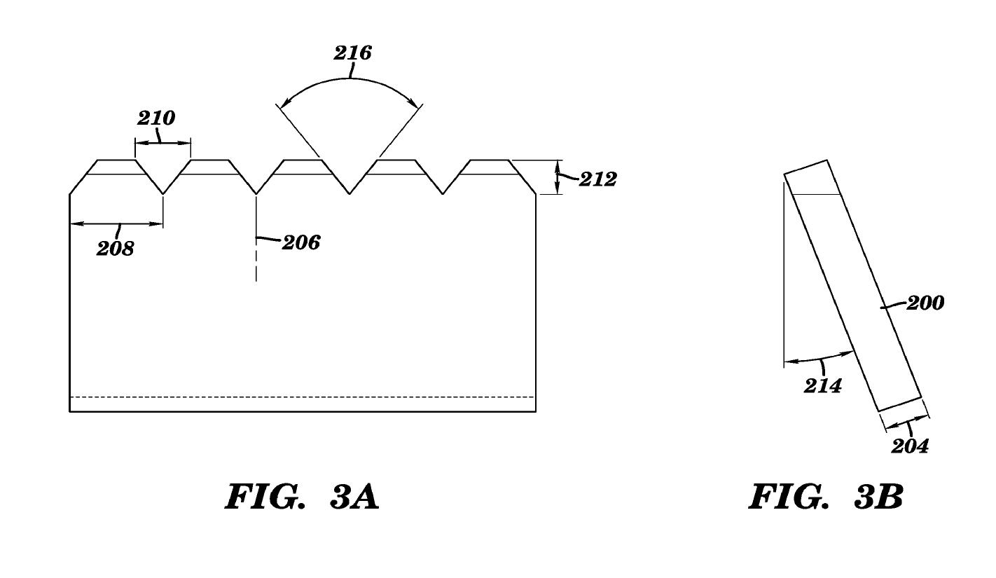

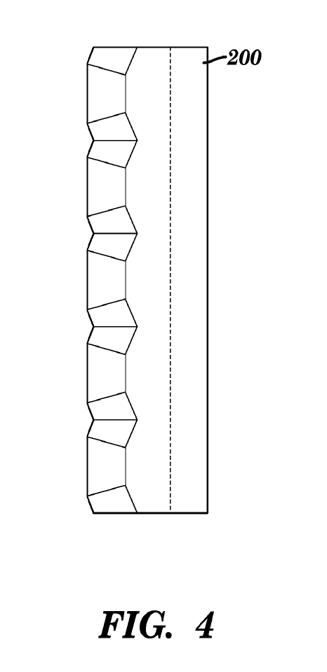

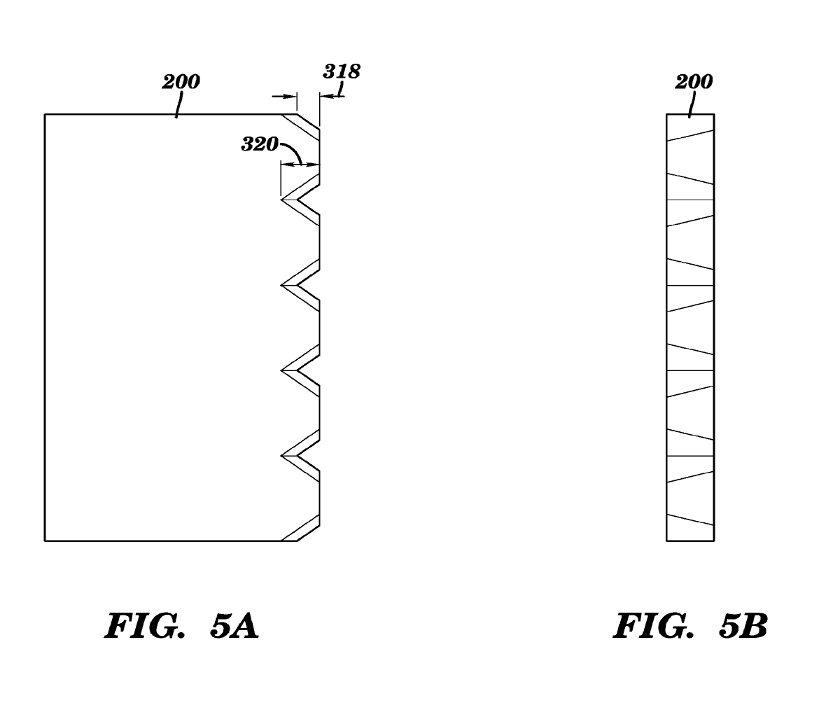

Referring to FIGS. 3A-B, the shim 200 held by the fixture is shown after the first cut of v-shaped grooves. The resulting shim 200 has four interior v-shaped grooves and a half v-shaped groove at each end. In one example, there are about 375 first v-shaped grooves along the shim 200 that has a length of about 4.5 inches, including a half v-shaped groove at each end, although any number of first v-shaped grooves and other shim lengths can also be used. Referring to FIG. 4, a top plan view of the shim 200 held by the fixture is shown after the first cut of v-shaped grooves. Referring to FIG. 5A, a side plan view of the shim 200 released from the fixture after the first cut of v-shaped grooves is shown. Due to the diamond angle 216 of the cutting tool and the incline angle 214 of the shim 200, the resulting v-shaped grooves have different depths 318, 320 at opposing sides. Referring to FIG. 5B, a top view of the shim 200 after the first cut of v-shaped grooves is shown.

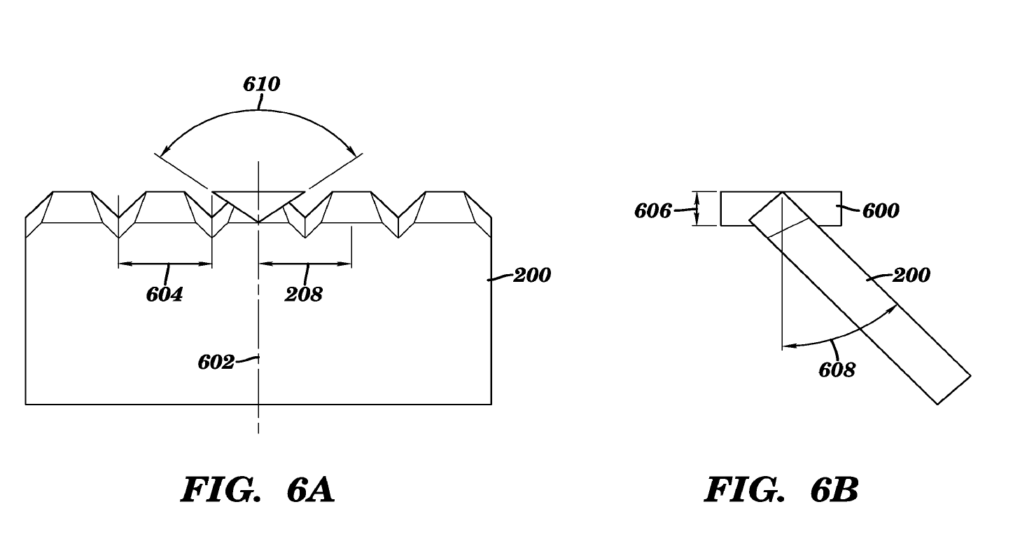

Referring back to FIG. 1, in step 104, the shim 200 is placed in a second fixture on the stage of the diamond cutting machine and held in place in a second rotated position. Referring to FIGS. 6-10, a second diamond cutting tool 600 of the diamond cutting machine is used to cut a plurality of second v-shaped grooves in the shim 200. The cut by the diamond cutting tool 600 can be a right edge cut, for example. Each of the v-shaped grooves are cut at points spaced apart and beginning from a starting point 602. In this example, the starting point 602 is defined at the longitudinal center of the shim 200.

The second v-shaped grooves have a pitch 208 that is the same as the pitch of the first v-shaped grooves in this example, although a different cut pitch can be used. The second v-shaped grooves also have a second width and a second depth 606. The second width can be between about 0.008 inches and 0.016 inches and the second depth can be between about 0.003 inches and 0.005 inches, and other widths and depths can also be used. The shim 200 is held in place by the fixture at a second rotated position having an incline angle 608 which can be within a range of about 35 degrees to about 55 degrees. The diamond cutting tool 600 is disposed at a second diamond angle 610 which can be within a range of about 100 degrees to about 120 degrees. Each of the second v-shaped grooves forms at least a portion of a second facet or planar surface in each of two adjacent cube corners of the plurality of cube corners to be cut into the shim 200, as described and illustrated below.

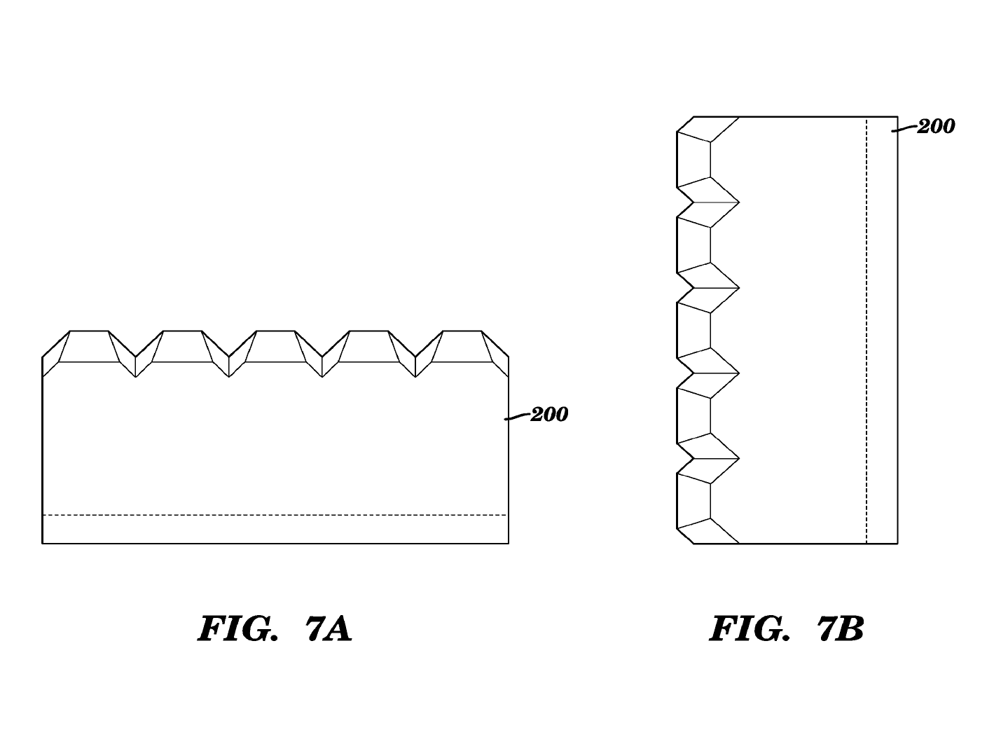

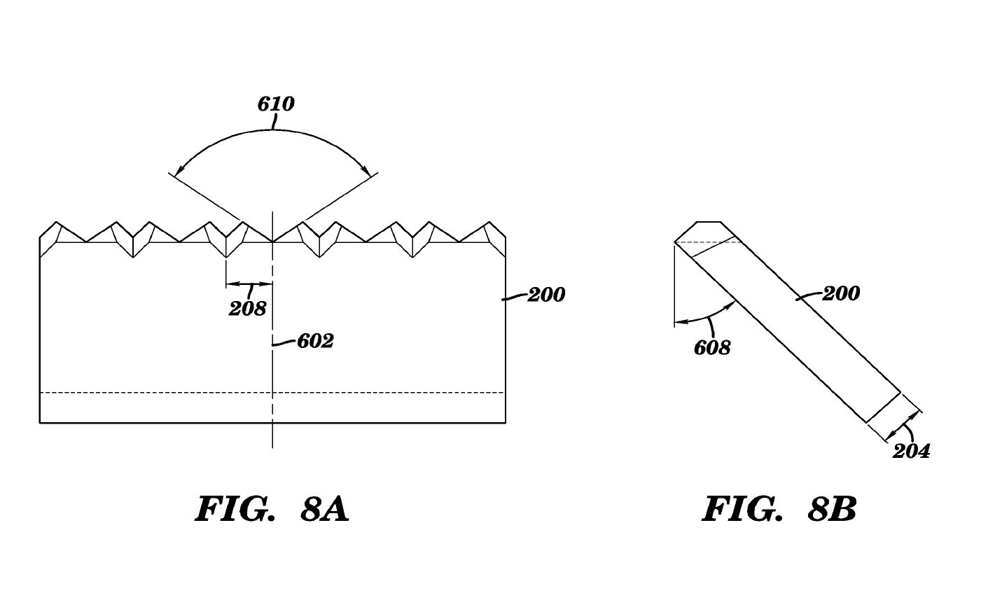

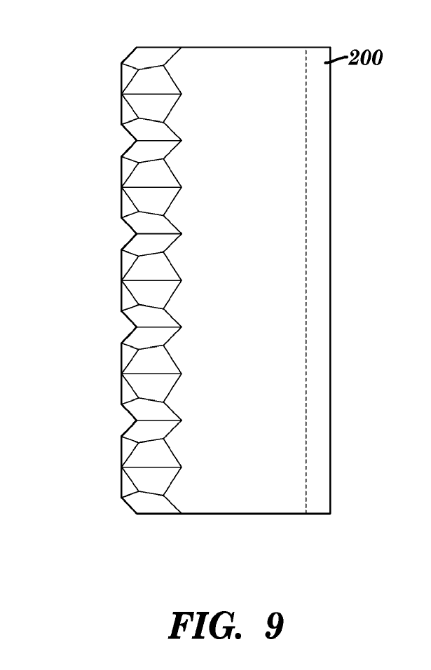

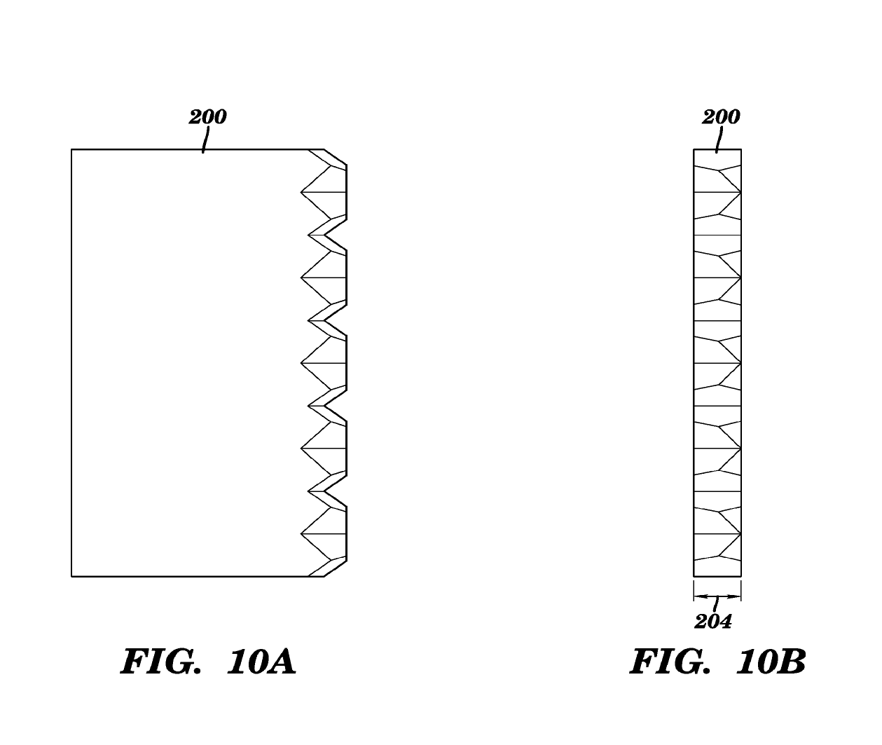

Referring to FIGS. 7A-B, a side view and a top view of the shim 200 held by the fixture before the second cut is shown. In the position shown in FIGS. 7A-B, the shim 200 is staged for the diamond cutting tool 600 to cut the second v-shaped grooves. Referring to FIGS. 8A-B, a front view and a side view of the shim 200 held by the fixture is shown after the second cut of v-shaped grooves. A top view of the shim 200 held by the fixture is shown in FIG. 9 after the second cut of v-shaped grooves. Referring to FIG. 10A, a side view of the shim 200 after the second cut of v-shaped grooves is shown. Referring to FIG. 10B, a top view of the shim 200 after the second cut of v-shaped grooves is shown. In one example, there are about 375 second v-shaped grooves along the shim that has a length of 4.5 inches, although any number of second v-shaped grooves and other shim lengths can also be used.

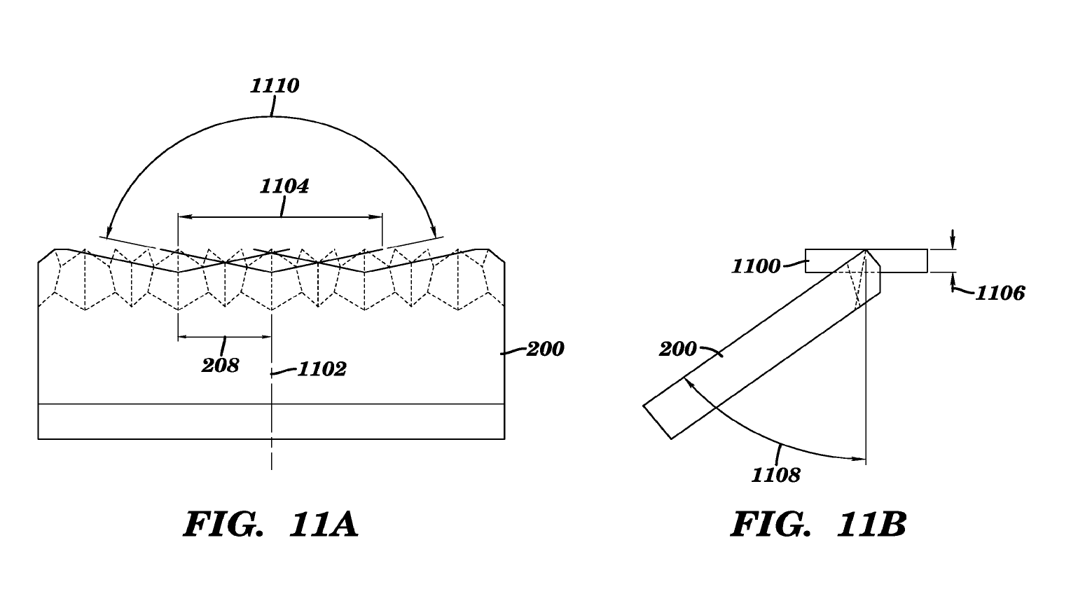

Referring back to FIG. 1, in step 106, the shim 200 is placed in a third fixture on the stage of the diamond cutting machine and held in place in a third rotated position. Referring to FIGS. 11-15, a third diamond cutting tool 1100 of the diamond cutting machine is used to cut a plurality of third v-shaped grooves. The cut by the diamond cutting tool 1100 in step 106 can be a left edge cut, for example. Each of the v-shaped grooves are cut at points spaced apart and beginning from a starting point 1102. In this example, the starting point 1102 is defined at the longitudinal center of the shim 200. In this example, the starting point 1102 for the third cut of v-shaped grooves is the same as the starting point 602 for the second cut of v-shaped grooves, although the starting points 602, 1102 can also be different.

The third v-shaped grooves have a pitch that is the same as the pitch 208 of the first and second v-shaped grooves in this example, although a different cut pitch can be used. The third v-shaped grooves also have a third width 1104 and a third depth 1106. The third width 1104 can be between about 0.014 inches and about 0.051 inches and the third depth 1106 can be between about 0.002 inches and about 0.0041 inches, and other widths and depths can also be used. The shim 200 is held in place by the fixture at a third rotated position having an incline angle 1108 which can be within a range of about 48 degrees to about 60 degrees. The diamond cutting tool 1106 is disposed at a third diamond angle 1110 which can be within a range of about 147 degrees to about 163 degrees. Each of the third v-shaped grooves forms at least a portion of a third facet or planar surface in each of two adjacent cube corners of the plurality of cube corners to be cut into the shim 200, as described and illustrated below.

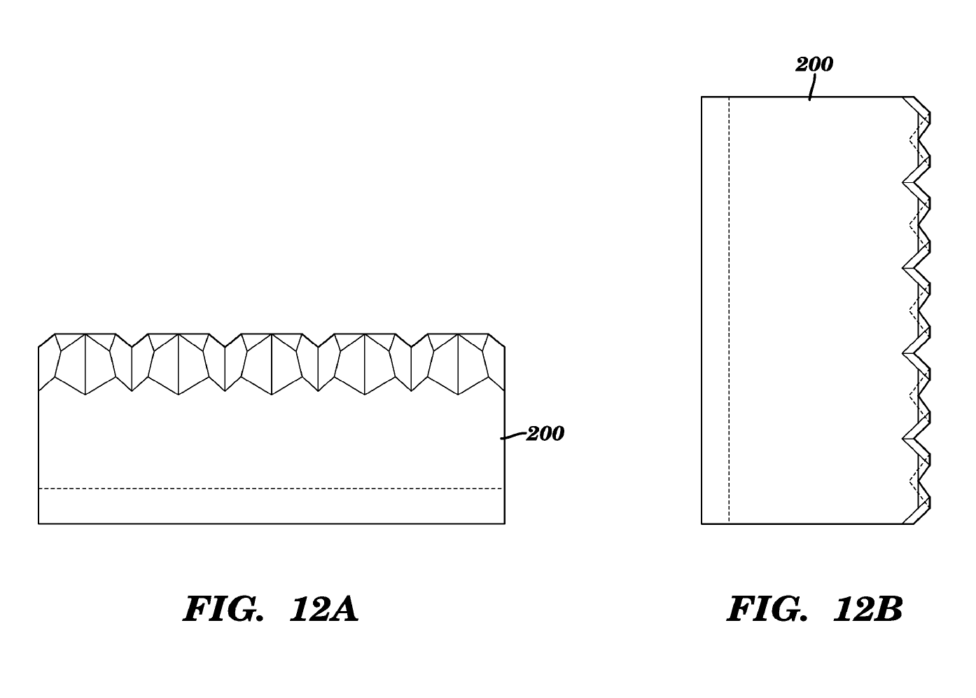

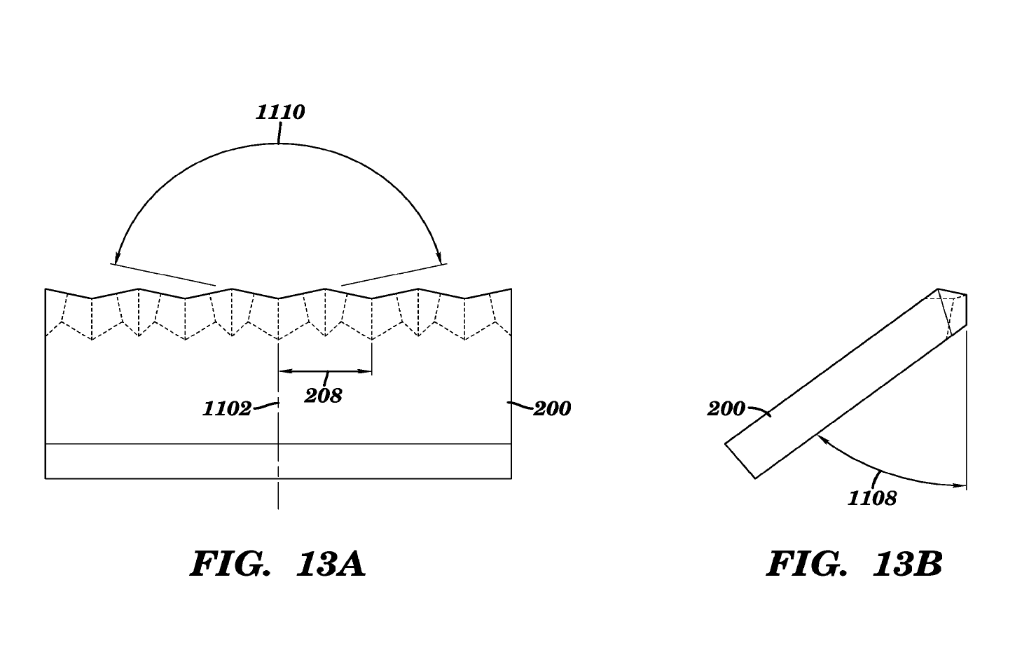

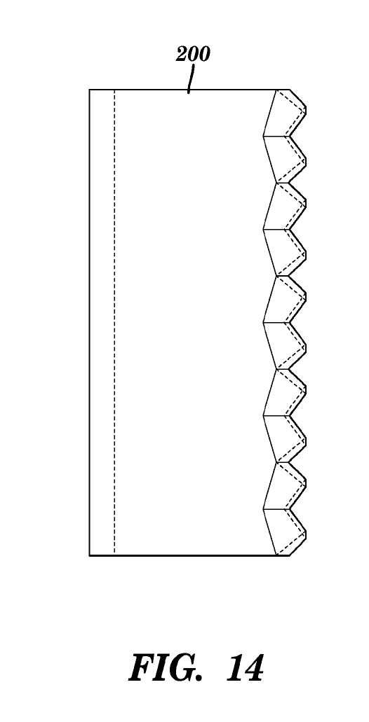

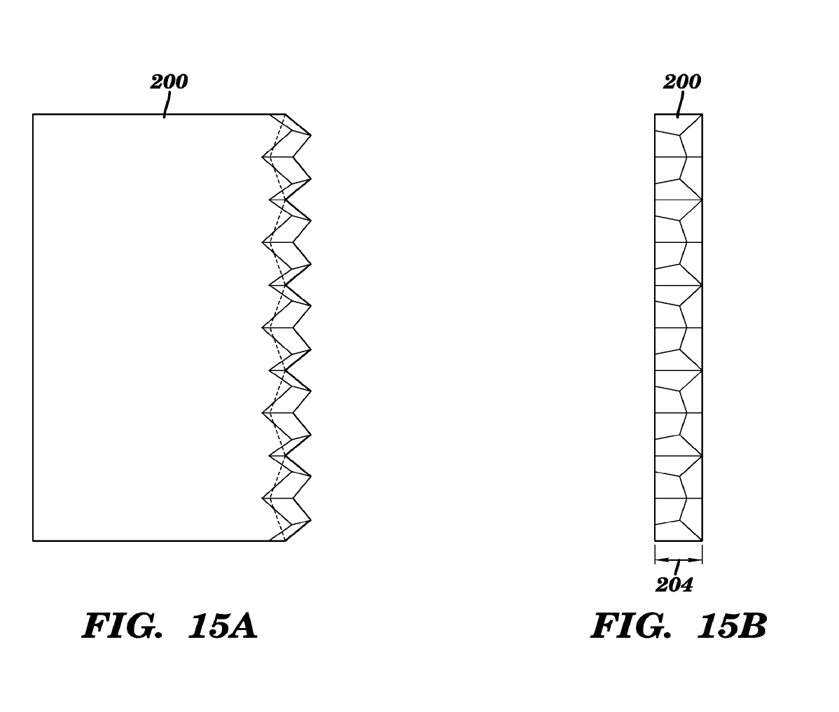

Referring to FIGS. 12A-B, a top view and side view of the shim 200 held by the fixture is shown before the third cut. In the position shown in FIG. 12, the shim 200 is staged for the diamond cutting tool 1100 to cut the third v-shaped grooves. Referring to FIGS. 13A-B, a front view and a side view of the shim 200 held by the fixture is shown after the third cut of v-shaped grooves. A top view of the shim 200 held by the fixture is shown in FIG. 14 after the third cut of v-shaped grooves. Referring to FIG. 15A, a side view of the shim 200 released from the fixture after the third cut of v-shaped grooves is shown. Referring to FIG. 15B, a top view of the shim 200 after the third cut of v-shaped grooves is shown. After the third cut of v-shaped grooves, the shim 200 contains a plurality of cube corners. In one example, there are about 375 third v-shaped grooves along the shim 200 that has a length of 4.5 inches, although any number of third v-shaped grooves and other shim lengths can also be used.

Referring back to FIG. 1, in step 108, it is determined whether additional shims are required in order to form a mold that can be used to form retroreflective articles. In some examples, an elementary or master mold comprising about 100 to about 400 shims is made, for example, although a mold with any number of shims can also be used. Accordingly, a plurality of shims may be required to make a mold including an array (a plurality of rows and/or columns) of cube corners. When it is determined, in step 108, that additional shims are required, the method proceeds back to step 102 and steps 102-106 are repeated. When it is determined, in the fourth step, that additional shims are not required, the method proceeds to the fifth step.

In step 110, each of the plurality of shims is joined to make an elementary or master mold. In step 112, the master mold is used to form a retroreflective sheet having the cube corner geometric features of the plurality of shims. Accordingly, in one example, about 4 to about 6 elementary molds are used to make a second generation or basic mold. The basic mold can then be used to test relatively small retroreflective articles to confirm the basic mold meets technical specifications. Then, the basic mold is replicated and the resulting basic molds are combined to form a belt. The belt is then used to form a retroreflective article, such as a retroreflective sheet. In other examples, any number of molds and/or mold generations can be created and/or used to create the retroreflective sheet.

### FIRST EXAMPLE

### Square Cube Corners

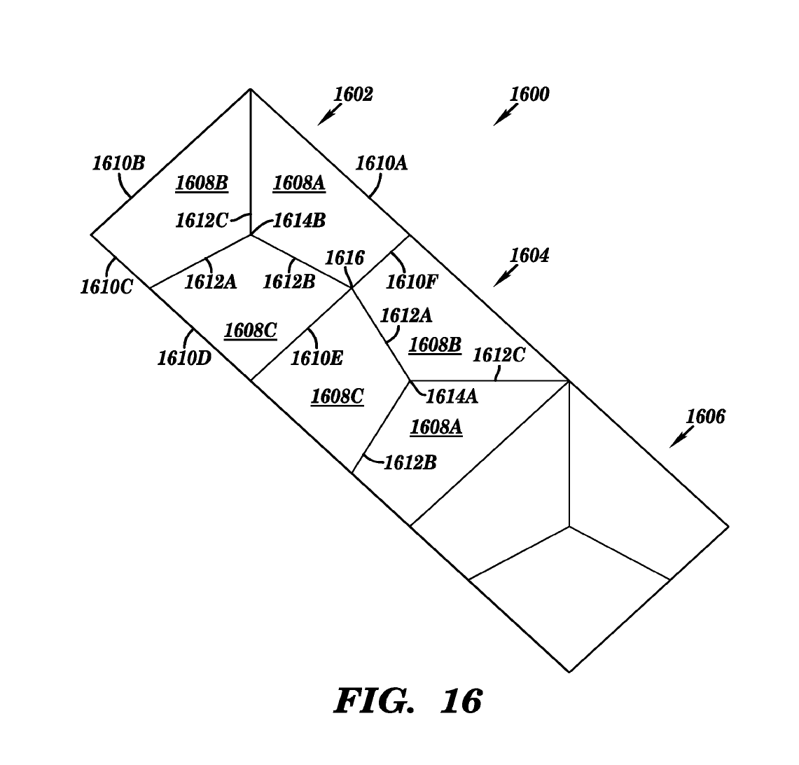

Referring to FIGS. 16-19, an exemplary shim 1600 formed according to steps 102-106 of FIG. 1 is shown. Referring specifically to FIG. 16, a plan view of three square cube corners 1602, 1604, and 1606 of the shim 1600 is shown. In this example, the square cube corners 1602, 1604, 1606 of the shim 1600 each have a square aperture and are disposed in an alternating orientation (alternately rotated 90 degrees), although other aperture shapes and orientations can also be used. The diamond cutting tools used in this example are symmetric. As described and illustrated above, each square cube corner 1602, 1604, 1606 has three facets (facets 1608A, 1608B, and 1608C), four exterior sides comprised of side portions (side portions 1610A, 1610B, 1610C and 1610D, and 1610E and 1610F), and three interior edges (edges 1612A, 1612B, and 1612C) that meet at an apex 1614A, 1614B.

Each of the square cube corners (e.g. cube corners 1602 and 1604) shares, with an adjacent one of the cube corners, at least one exterior side (the side comprised of side portions 1610E and 1610F in this example) intersected at substantially the same point 1616 in this example, although alternative configurations can also be used, such as described and illustrated below, for example.

Optionally, the apex 1614A, 1614B of each of the square cube corners (e.g. 1602 and 1604) is disposed substantially at the center of an aperture base portion (defined by the four exterior sides comprised of side portions 1610A, 1610B, 1610C and 1610D, and 1610E and 1610F) of each of the cube corners. The diagonal lines connecting a respective pair of opposing corners of each square cube corner intersect and are perpendicular at each apex 1614A, 1614B, indicating that the apex 1614A, 1614B is disposed at the geometric center of each of the cube cornersl602 and 1604. In this example, one of the interior edges (edge 1612C) in each of the square cube corners 1602 and 1604 is substantially aligned with a respective one of the diagonal lines.

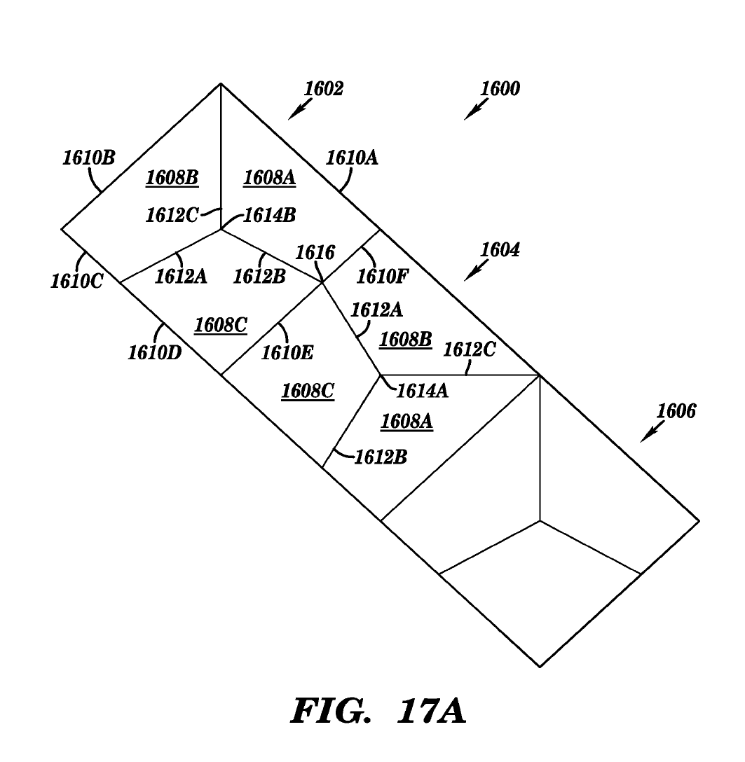

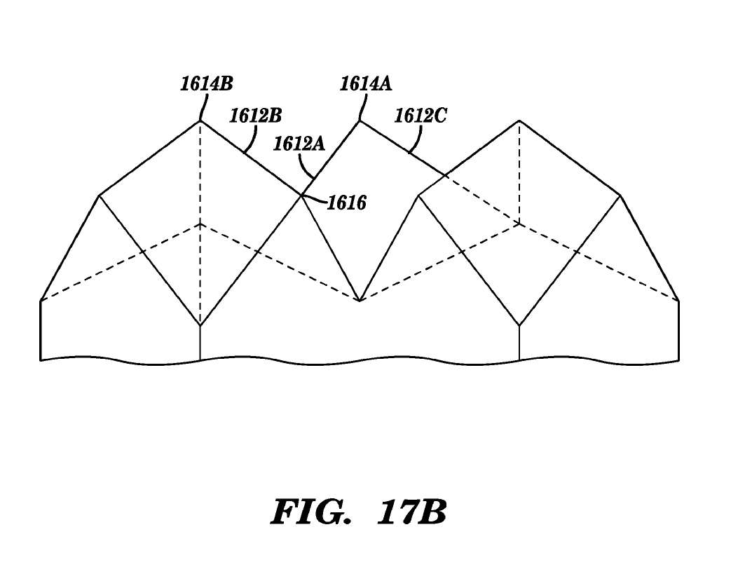

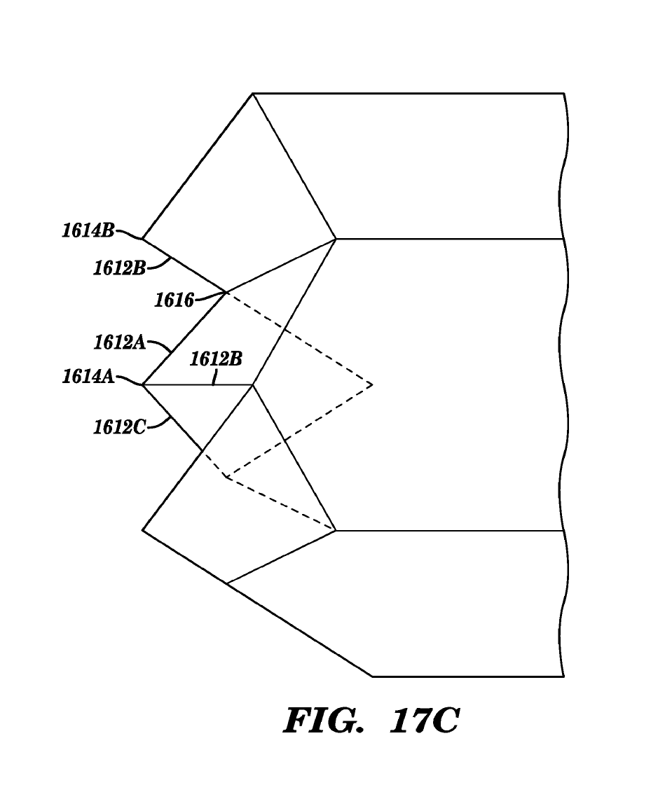

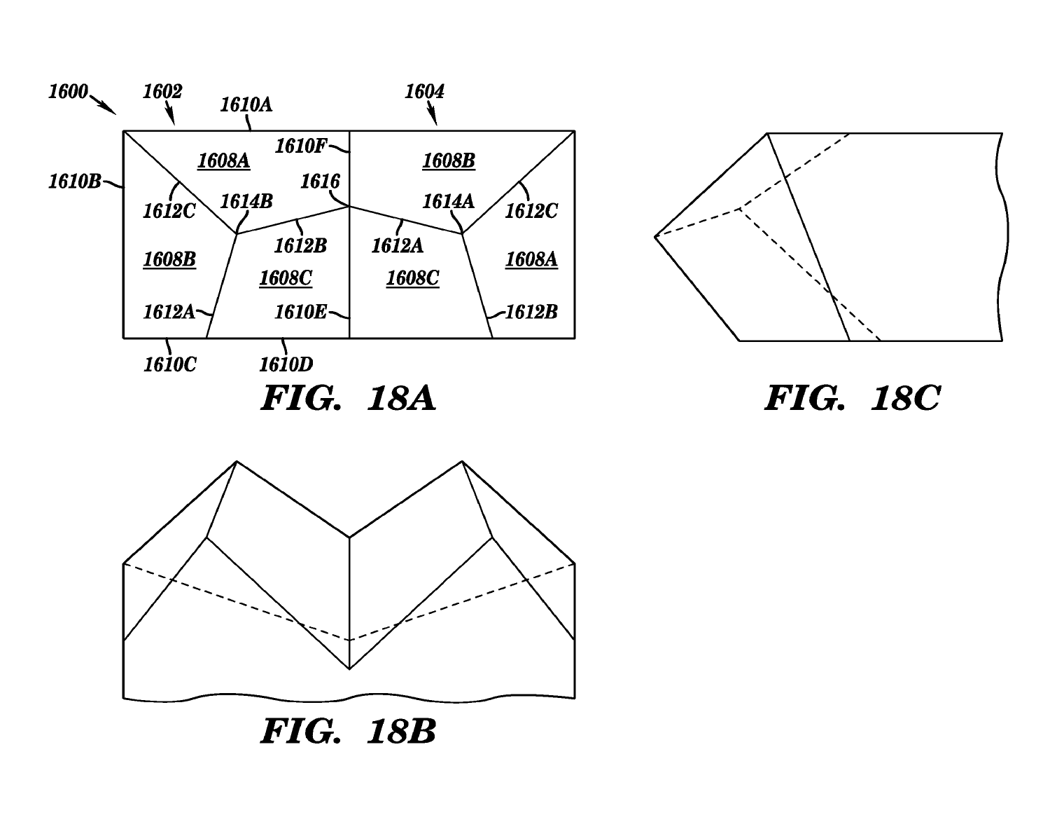

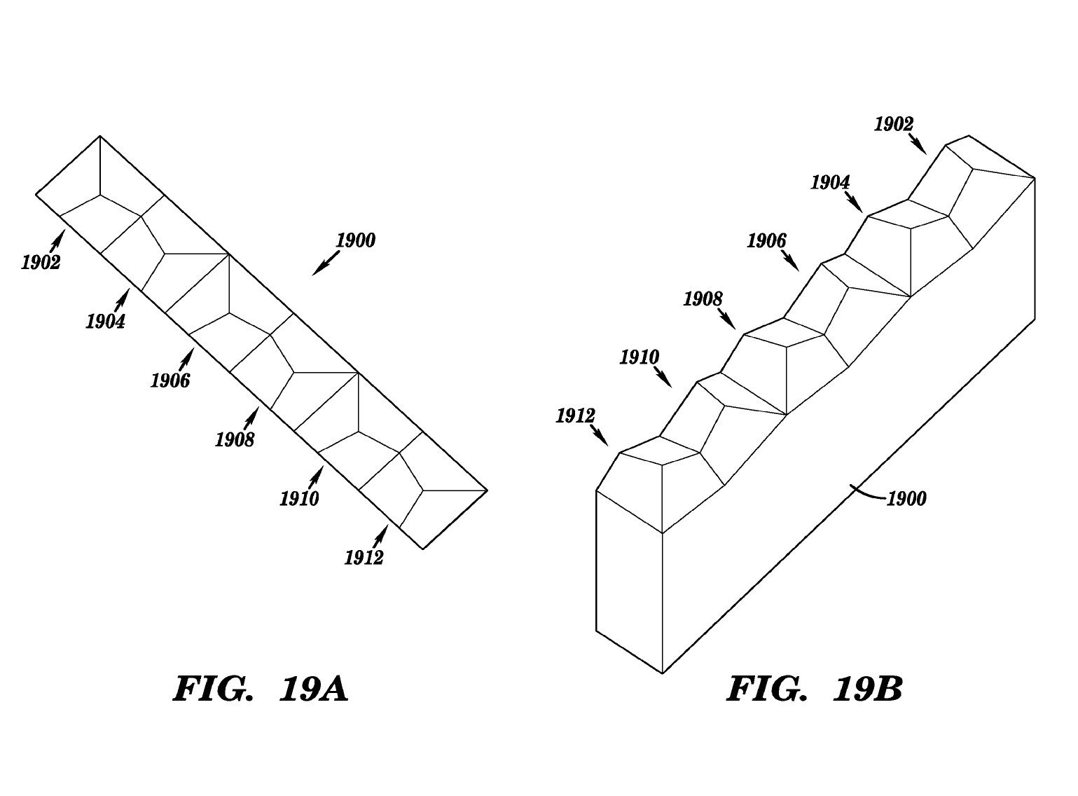

Referring to FIGS. 17A-C, a top view and two perspective views of a portion of the shim 1600 including the three square cube corners 1602, 1604, 1606 of FIG. 16 are shown. Referring to FIGS. 18A-C, a top view and two perspective views of a portion of the shim 1600 including two of the cube corners 1604, 1606 of FIGS. 16-17 are shown. Referring to FIGS. 19A-B, a top view and a perspective view of a shim 1900 formed as described above is shown. The shim 1900 includes six cube corners 1902, 1904, 1906, 1908, 1910, and 1912 although any number of cube corners can be cut in each shim. In one example, a 4.5 inch long shim includes about 750 rhombus cube corners including about 375 cube corners having a vertical edge 1612C and about 375 rhombus cube corners having a horizontal edge 1612C distributed alternately along the shim

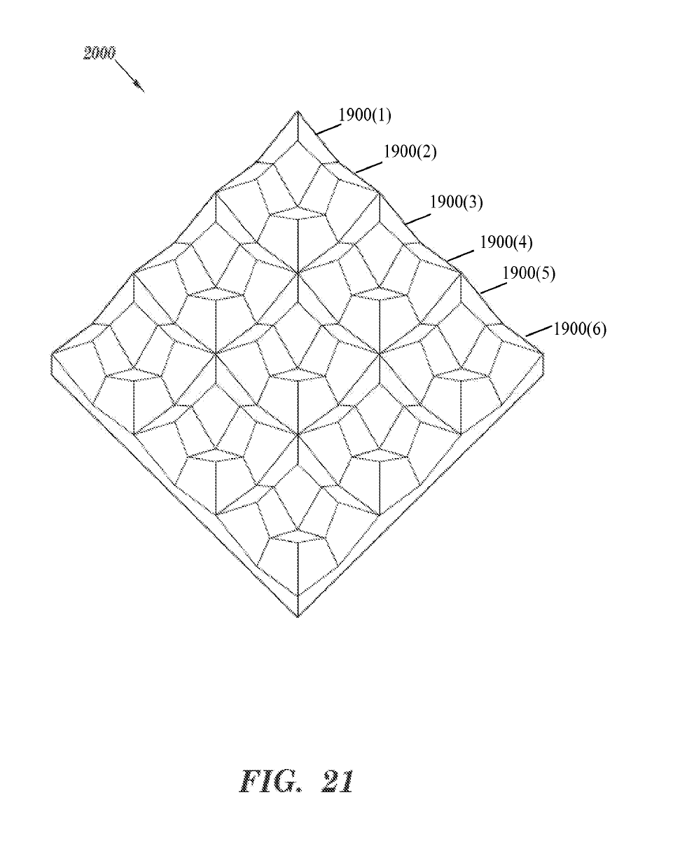

Referring to FIG. 20, a top plan view of a plurality of shims 1900(1)-(6) joined together to form a basic mold 2000 is shown as including a 6×6 array of square cube corners. The shims 1900(1)-(6) can be joined together based on the planar properties of their adjacent edges. In this example, the shims 1900(1)-(6) are joined together in an alternating orientation such that a shared side, as described above with respect to the example shown in FIGS. 16-19, is located between each adjacent cube corner. Referring to FIG. 21, a perspective view of the mold 2000 shown in FIG. 20 is shown. In one example, a basic mold 2000 has an area of 4.5 inches by 4.5 inches, which has about 750 shims and about 562,500 rhombus cube corners, although other sizes of basic molds can also be used.

### SECOND EXAMPLE

### Rhombus Cube Corners

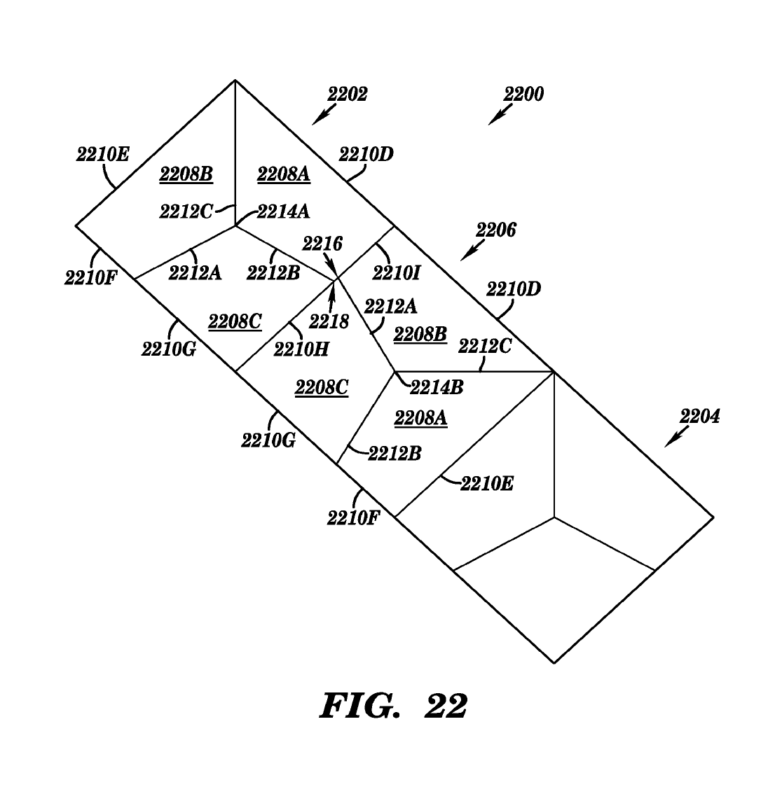

Referring to FIGS. 22-26, another exemplary shim 2200 formed according to steps 102-106 of FIG. 1 is shown. Referring specifically to FIG. 22, a top view of three rhombus cube corners of the shim in this example includes two obtuse angle rhombus cube corners 2202, 2204 and one acute angle rhombus cube corner 2206. As described and illustrated above, each rhombus cube corner 2202, 2204, and 2206 has three facets (facets 2208A, 2208B, and 2208C). In this example, the obtuse angle 2202, 2204 and acute angle 2206 rhombus cube corners are alternating. Each rhombus cube corner 2202, 2204, and 2206 has four exterior sides comprising side portions (side portions 2210D, 2210E, 2210F, 2210G, 2210H and 22101) and three interior edges (edges 2212A, 2212B, and 2212C) that meet at an apex 2214A and 2214B. The obtuse angle rhombus cube corners 2202, 2204 and acute angle rhombus cube corner 2206 result from three cuts each as described and illustrated earlier with respect to the steps 102-106 of FIG. 1. The cuts in this example are made with asymmetric diamond cutting tools and cut paths not perpendicular to the shim 2200 and disposed at an offset angle substantially parallel to the stage surface of the diamond cutting machine.

One or more cuts of the series of obtuse angle rhombus cube corners 2202, 2204 differ in degree as compared to one or more corresponding cuts of the series of acute angle rhombus cube corners 2206, such as with respect to diamond angle, incline angle, cut depth, and/or cut width. Optionally, both obtuse 2202, 2204 and acute angle 2206 rhombus cube corners have the same pitch and the same horizontal offset angle. In one example, the cut pitch is 0.012 inches, the double of shim thickness, and the offset angle is 6 degrees, although other cut pitches and other offset angles can also be used. There are therefore six series cuts along the shim 2200 in total made with the three diamond cutting tools.

Each of the obtuse angle rhombus cube corners 2202, 2204 shares, with an adjacent one of the acute angle rhombus cube corners 2206, at least one exterior side (comprised of sides portions 2210H and 2210I in this example) intersected at two points (points 2216 and 2218 in this example) spaced apart by a respective one of the interior edges of each of the adjacent rhombus cube corners (edge 2212B of the obtuse angle rhombus cube corner 2202 and edge 2212A of the acute angle rhombus cube corner 2206 in this example). The obtuse angle 2202, 2204 and acute angle 2206 rhombus cube corners can be defined based on an intersection of one of the exterior sides of each rhombus cube corner 2202, 2204, 2206 at the same first end of the shared side. In this example, one exterior side (comprised of side portions 2210F and 2210G of the obtuse angle rhombus cube corner 2202 in this example) intersects the shared side (comprised of side portions 2210H and 2210I in this example) at a first end 2220 to form an obtuse angle. Exterior side (comprised of side portions 2210F and 2210G of the acute angle rhombus cube corner 2204 in this example) intersects the shared side (comprised of side portions 2210H and 2210I in this example) at the first end to form an actue angle.

Optionally, each of the obtuse angles of each rhombus cube corner are substantially the same and each of the acute angles are substantially the same. Also optionally, one of the obtuse angles and one of the acute angles are substantially equal to 180 degrees such that the edges of the rhombus cube corners intersecting at the ends of the shared side (comprised of side portions 2210H and 2210I in this example) are substantially aligned. The resulting obtuse angles of the rhombus cube corners can be within a range of about 90 degrees to about 120 degrees and each of the acute angles can be within a range of about 90 degrees to about 60 degrees.

Also optionally, the apex 2214A, 2214B of each of the rhombus cube corners 2202, 2204 is disposed substantially at the center of a rhombus aperture base portion (defined by the four exterior sides) of each of the cube corners. The rhombus center lines connecting a respective pair of opposing corners of each rhombus cube corner 2202, 2204 intersect and are perpendicular at each apex 2214A, 2214B, indicating that the apex 2214A, 2214B is disposed at the geometric center of each of the rhombus cube corners 2202, 2204. In this example, one of the interior edges (edge 2212C) in each of the rhombus cube corners 2204, 2204 is substantially aligned with a respective one of the rhombus center lines that intersct at the first end of the shared edge (comprised of side portions 2210H and 2210I in this example).

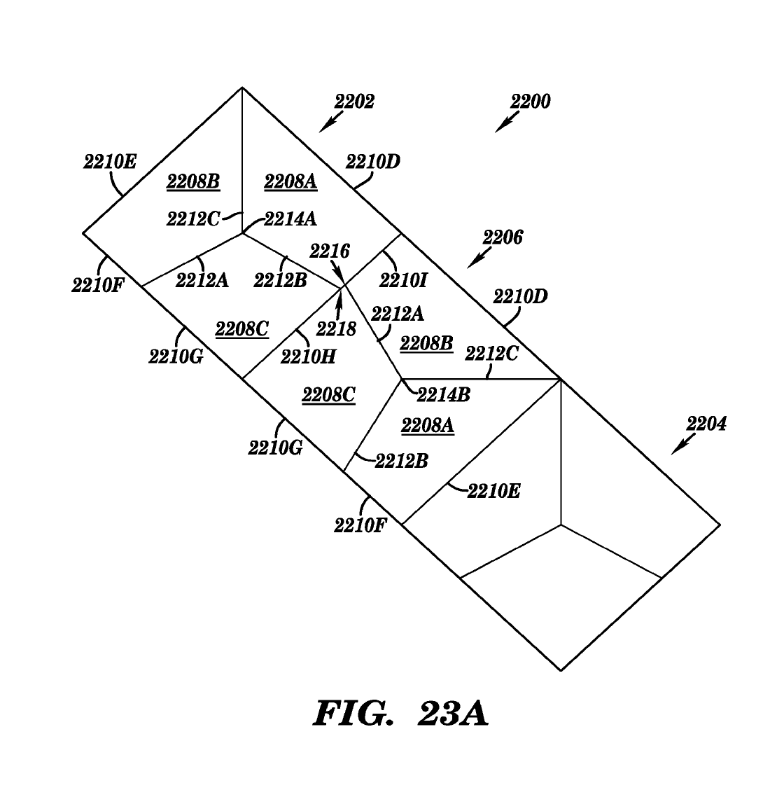

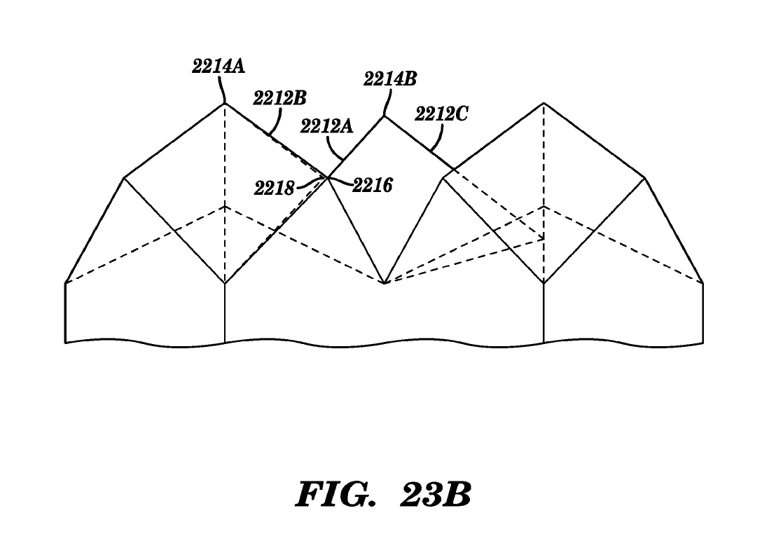

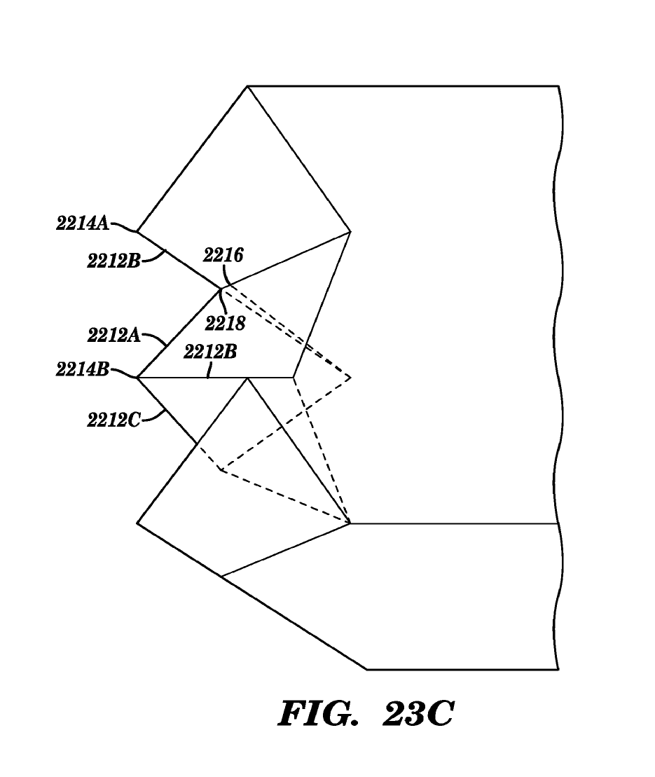

Referring to FIGS. 23A-C, a top view and two perspective views of the portion of the shim 2200 including the rhombus cube corners 2202, 2204, and 2206 of FIG. 22 are shown. In this example, the apex 2214A of the obtuse angle rhombus cube corners 2202, 2204 are disposed at a higher height than the the apex 2214B of the acute angle rhombus cube corner 2206

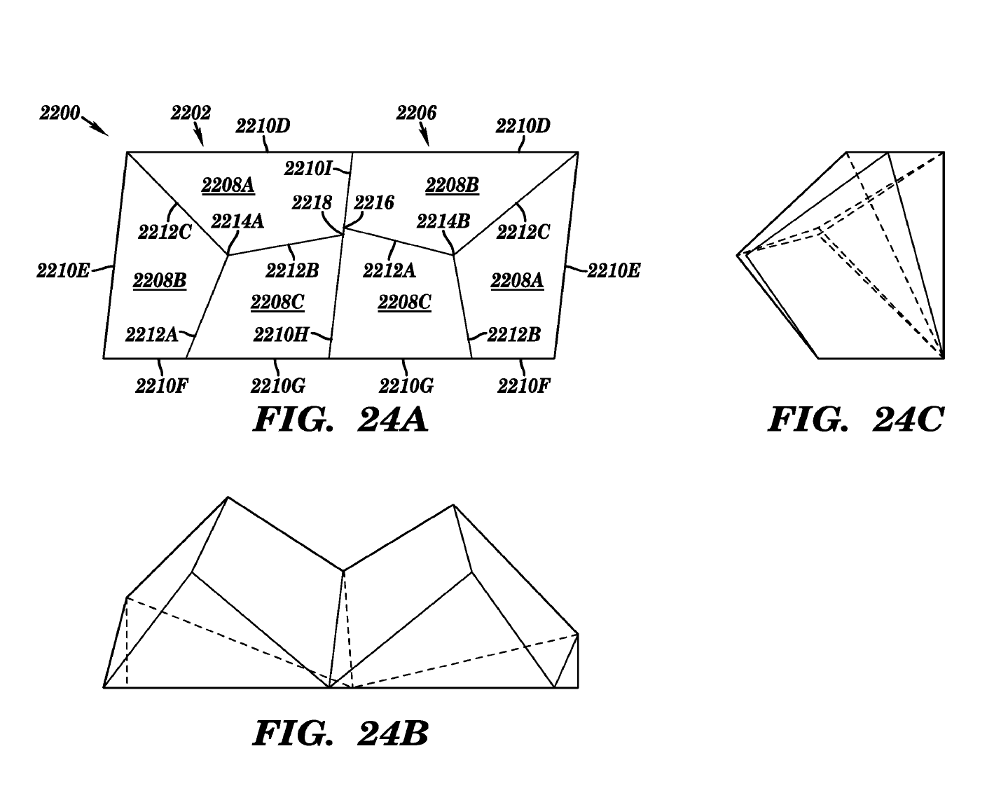

Referring to FIGS. 24A-C, a top view and two perspective views of a portion of the shim 2200 including two of the rhombus cube corners 2202, 2206 of FIGS. 22-23 are shown. Points 2216 and 2218 are shown spaced apart.

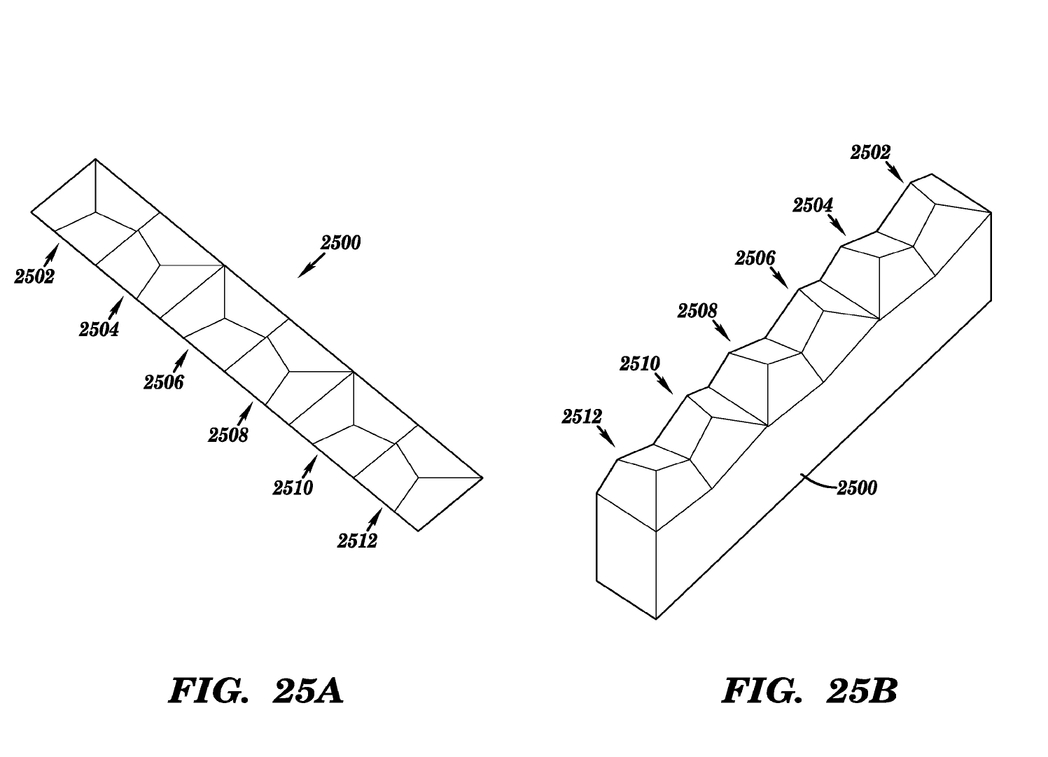

Referring to FIGS. 25A-B, a top view and a perspective view of a shim 2500 formed as described above is shown. The shim 2500 includes six rhombus cube corners 2502, 2504, 2506, 2508, 2510, 2512, although any number of rhombus cube corners can be cut in each shim 2500. A typical 4.5 inch long shim 2500 has 375 obtuse angle rhombus cube corners 2502, 2506, and 2510 and 375 acute angle rhombus cube corners 2504, 2508, and 2512 alternately distributed along the shim 2500.

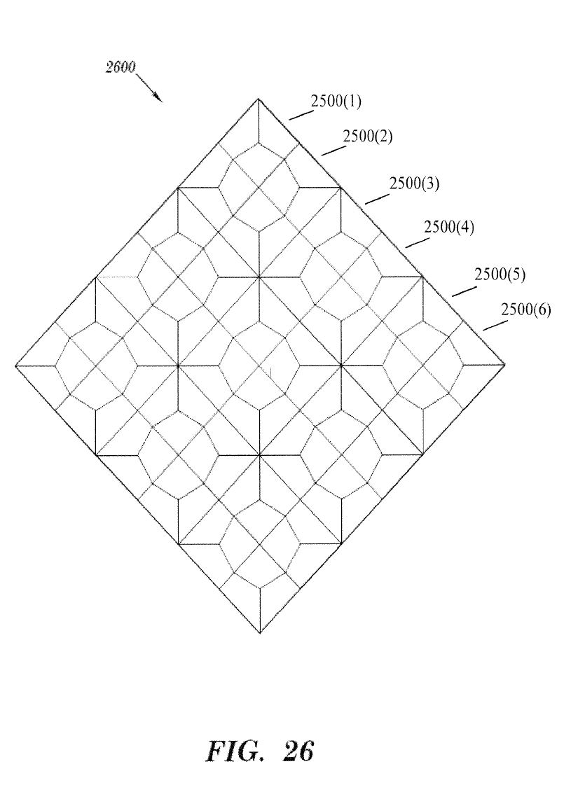

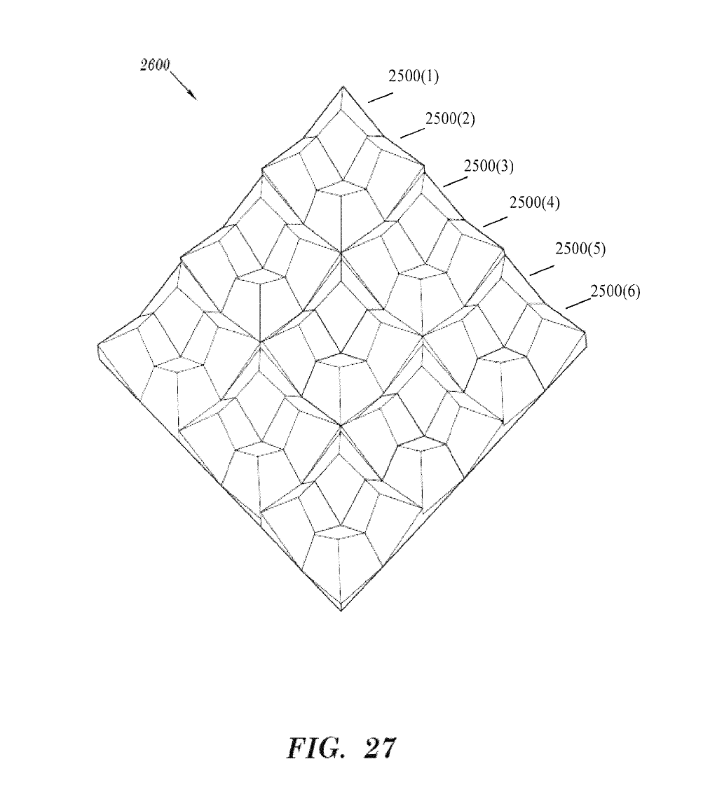

Referring to FIG. 26, a top plan view of a plurality of shims 2500(1)-(6), formed according to this example, joined together to form a basic mold 2600 for making a retroreflective article, such as a retroreflective sheet, is shown. In this example, the shims 2500(1)-(6) are joined together in an alternating reverse oriented position such that a shared side, as described above with respect to the example shown in FIGS. 22-25, is located between each adjacent rhombus cube corner. Referring to FIG. 27, a perspective view of the basic mold 2600 shown in FIG. 26 for making a retroreflective article is shown. In one example, a basic mold 2600 of mixed obtuse and acute angle rhombus cube corners can have an area of about 4.5 inches by about 4.5 inches, and can include about 750 shims, each shim having about 375 obtuse angle rhombus cube corners and about 375 acute angle rhombus cube corners, and thus about 562,500 rhombus cube corners in total including about 281,250 obtuse angle rhombus cube corners and about 281,250 acute angle rhombus cube corners, although any size shim and number of cube corners can also be used.

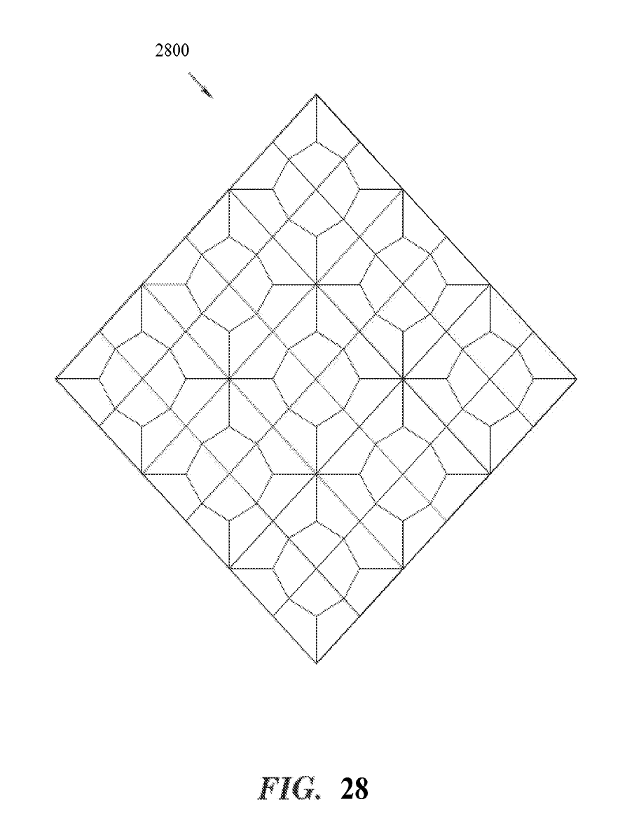

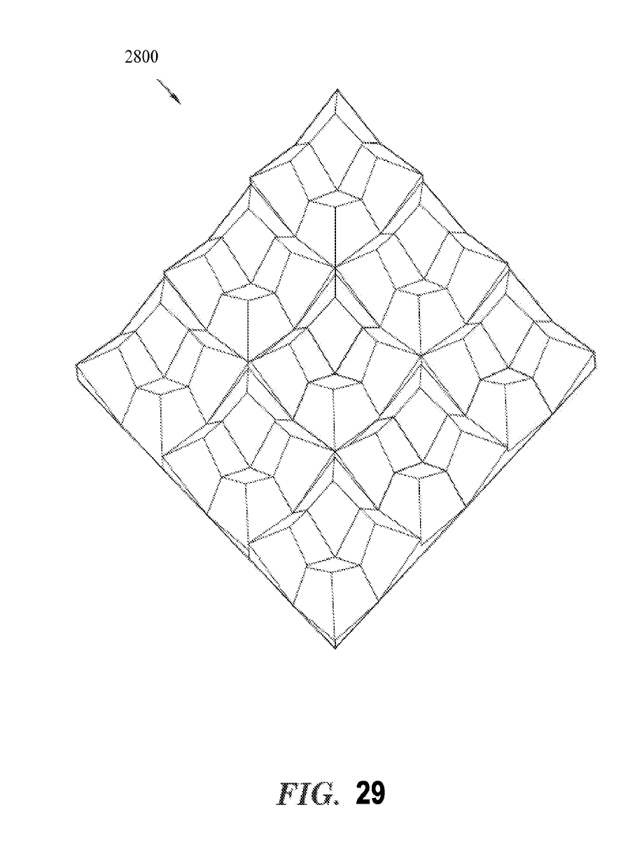

Referring to FIGS. 28-29, a top plan view and a perspective view, respectively, of a retroreflective article 2800, such as a retroreflective sheet, is illustrated. The retroreflective article 2800 can be formed using the mold 2600 as described and illustrated earlier with reference to step 112 of FIG. 1, for example. although other methods of forming the retroreflective article 2800 can also be used.

As illustrated and described herein this technology provides a number of advantages including providing a mold for forming a retroreflective sheet having increased retroreflective output as compared to a retroreflective sheet having rectangular geometric features. The retroreflective sheet according to this technology also has a lower aspect ratio and is therefore easier to manufacture than a retroreflective sheet having rectangular geometric features. Additionally, the retroreflective sheet according to this technology can exhibit complete retroreflectivity without a mold having symmetric geometric features or adjacent mirror image geometric features. The retroreflective sheet formed using the rhombus cube corner mold of this technology exhibits symmetry in both vertical and horizontal directions and in both 45 degree and 135 degree directions. The retroreflective sheet exhibits much better performance than rectangular full cube corners with respect to orientation angles.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A mold for forming a retroreflective article, the mold comprising:
a plurality of cube corners, each of the cube corners comprising three facets each comprising a planar surface, four exterior sides, and three interior edges, the three interior edges meeting at an apex; and
wherein each of the cube corners shares, with an adjacent one of the cube corners, at least one exterior side comprising two side portions intersected by a respective one of the interior edges of each of the adjacent cube corners.

2. The mold as set forth in claim 1 wherein:
the plurality of cube corners comprise a plurality of square cube corners each having a square aperture; and
the at least one exterior side is intersected at substantially the same point by one of the interior edges of each of the adjacent cube corners.

3. The mold as set forth in claim 1 wherein the apex of each of the cube corners is disposed substantially at the center of a aperture base portion of each of the cube corners.

4. The mold as set forth in claim 1 wherein the apex of each of the cube corners is disposed substantially at the intersection of two diagonal lines of each of the cube corners wherein the diagonal lines each connect a respective pair of opposing corners of each of the cube corners and the diagonal lines are perpendicular.

5. The mold as set forth in claim 4 wherein one of the interior edges of each of the cube corners is substantially aligned with one of the diagonal lines.

6. The mold of claim 1, wherein the plurality of cube corners comprises a plurality of alternating obtuse angle and acute angle rhombus cube corners, wherein one of the exterior sides of each of the acute angle rhombus cube corners intersects the shared exterior side at a first end to form an acute angle and one of the exterior sides of each of the obtuse angle rhombus cube corners intersects the shared exterior side at the first end to form an obtuse angle.

7. The mold of claim 6 wherein:
each of the obtuse angles is within a range of about 90 degrees to about 120 degrees and each of the acute angles is within a range of about 90 degrees to about 60 degrees;
each of the obtuse angles are substantially the same;
each of the acute angles are substantially the same; and
the sum of one of the obtuse angles and one of the acute angles is substantially equal to 180 degrees.

8. The mold as set forth in claim 6 wherein the at least one shared exterior side is intersected at two points spaced apart by the respective one of the interior edges of each of the adjacent rhombus cube corners.

9. A method for making a mold for forming a retroreflective article, the method comprising:
cutting, with a first diamond cutting tool of a diamond cutting machine, a plurality of first v-shaped grooves in a shim held by a fixture in a first rotated position, the first v-shaped grooves having a pitch, a first width, and a first depth, wherein the tool is disposed at a first diamond angle and the first v-shaped grooves form at least a portion of a first facet in each of a plurality of cube corners;
cutting, with a second diamond cutting tool of the diamond cutting machine, a plurality of scond v-shaped grooves in a shim held by a fixture in a second rotated position, the second v-shaped grooves having the pitch, a second width, and a second depth, wherein the tool is disposed at a second diamond angle and the second v-shaped grooves form at least a portion of a second facet in each of the plurality of cube corners;and
cutting, with a third diamond cutting tool of the diamond cutting machine, a plurality of third v-shaped grooves in a shim held by a fixture in a third rotated position, the third v-shaped grooves having the pitch, a third width, and a third depth, wherein the tool is disposed at a third diamond angle, and the third v-shaped grooves form at least a portion of a third facet in each of the plurality of cube corners;
repeating the cuting steps for a plurlaity of shims; and
joining the plurality of shims together.

10. The method as set forth in claim 9 wherein the cutting steps further comprise cutting the v-shaped grooves from a respective starting point, wherein the starting point for cutting the second and third v-shaped grooves is substantially the same and is disposed longitudinally along a center line of the shim and the starting point for cutting the first v-shaped grooves is a point spaced substantially a thickness of the shim from the starting point for the second and third v-shaped grooves.

11. The method as set forth in claim 9 wherein the shim has a substantially uniform thickness ranging from about 0.0040 inches to about 0.0080 inches and the pitch is twice the thickness of the shim.

12. The method as set forth in claim 9 wherein the first diamond angle is within a range of about 65 degrees to about 87 degrees, the second diamond angle is within a range of about 100 degrees to about 120 degrees, and the third diamond angle is within a range of about 147 degrees to about 163 degrees.

13. The method as set forth in claim 9 wherein the first, second, and third rotated positions correspond with first, second, and third incline angles, respectively, of the shim and the first inclined angle is within a range of about 15 degrees to about 25 degrees, the second inclined angle is within a range of about 35 degrees to about 55 degrees, and the third inclined angle is within a range of about 48 degrees to about 60 degrees.

14. The method as set forth in claim 9 wherein the cutting the first and second v-shaped grooves further comprises making a right edge cut of the shim and the cutting the third v-shaped grooves further comprises making a left edge cut of the shim.

15. The method as set forth in claim 9 wherein the diamond cutting machine further includes a stage surface and a cutting path for the first, second, third, v-shaped grooves is substantially perpendicular to the shim and substantially parallel to the stage surface.

16. The method as set forth in claim 9 wherein the the diamond cutting tools comprise symmetric cutting surfaces and the plurality of cube corners comprises a plurality of square cube corners, each having a square aperture base portion.

17. The method as set forth in claim 9 wherein the apex of each of the cube corners is disposed substantially at the center of an aperture base portion of each of the cube corners and at the intersection of two diagonal lines of each of the cube corners wherein the diagonal lines each connect a respective pair of opposing corners of each of the cube corners and the diagonal lines are perpendicular

18. The method as set forth in claim 9 wherein the first plurality of cube corners comprises a plurality of rhombus cube corners comprising a plurality of obtuse angle rhombus cube corners and the first, second, and third diamond cutting tools comprise first and second asymmetric cutting surfaces, the first cutting surface corresponding with an obtuse angle of the obtuse angle rhmbus cube corners and the second cutting surface is substantially vertical.

19. The method as set forth in claim 18, further comprising:
cutting, with a fourth diamond cutting tool of the diamond cutting machine, a plurality of fourth v-shaped grooves in a shim held by a fixture in a fourth rotated position, the fourth v-shaped grooves having the pitch, a fourth width, and a fourth depth, wherein the tool is disposed at a fourth diamond angle and the fourth v-shaped grooves form at least a portion of a first facet in each of a second plurality of cube corners;
cutting, with a fifth diamond cutting tool of the diamond cutting machine, a plurality of fifth v-shaped grooves in a shim held by a fixture in a second rotated position, the fifth v-shaped grooves having the pitch, a fifth width, and a fifth depth, wherein the tool is disposed at a fifth diamond angle and the fifth v-shaped grooves form at least a portion of a second facet in each of the second plurality of cube corners; and
cutting, with a sixth diamond cutting tool of the diamond cutting machine, a plurality of sixth v-shaped grooves in a shim held by a fixture in a sixth rotated position, the sixth v-shaped grooves having the pitch, a sixth width, and a sixth depth, wherein the tool is disposed at a sixth diamond angle, and the sixth v-shaped grooves form at least a portion of a third facet in each of the second plurality of cube corners.

20. The method as set forth in claim 19, wherein the second plurality of cube corners comprises a plurlaity of acute angle rhombus cube corners and the fourth, fifth, and sixth diamond cutting tools have first and second asymmetric cutting surfaces, the first cutting surface corresponding with an acute angle of the acute angle rhombus cube corners and the second cutting surface is substantially vertical.

21. The method as set forth in claim 20, wherein the apex of each of the obtuse angle rhombus cornercubes is disposed at a lower height than the apex of each of the acute angle rhombus cornercubes.

22. The method as set forth in claim 20, wherein the diamond cutting machine further includes a stage surface and a cutting path for the first, second, third, fourth, fifth, and sixth v-shaped grooves is not perpendicular to the shim and disposed at an offset angle substantially parallel to the stage surface.

23. A method for forming a retroreflective article, the method comprising:
providing a mold comprising a plurality of shims joined together wherein each of the shims comprises a plurality of alternating cube corners, each of the cube corners comprising three facets each comprising a planar surface, four exterior sides, and three interior edges, the three interior edges meeting at an apex, wherein each of the cube corners shares, with an adjacent one of the cube corners, at least one exterior side intersected by a respective one of the interior edges of each of the adjacent cube corners; and
forming a retroreflective article using the mold, the retroreflective article comprising geometric structures corresponding to the cube corners of the plurality of shims of the mold.

24. A retroreflective article, comprising:
a plurality of cube corners, each of the cube corners comprising three facets each comprising a planar surface, four exterior sides, and three interior edges, the three interior edges meeting at an apex; and
wherein each of the cube corners shares, with an adjacent one of the cube corners, at least one exterior side comprising two side portions intersected by a respective one of the interior edges of each of the adjacent cube corners.

25. The retroreflective article as set forth in claim 24 wherein:
the plurality of cube corners comprise a plurality of square cube corners each having a square aperture; and
the at least one exterior side is intersected at substantially the same point by one of the interior edges of each of the adjacent cube corners.

26. The retroreflective article as set forth in claim 24 wherein the apex of each of the cube corners is disposed substantially at the center of a aperture base portion of each of the cube corners.

27. The retroreflective article as set forth in claim 24 wherein the apex of each of the cube corners is disposed substantially at the intersection of two diagonal lines of each of the cube corners wherein the diagonal lines each connect a respective pair of opposing corners of each of the cube corners and the diagonal lines are perpendicular.

28. The retroreflective article as set forth in claim 27 wherein one of the interior edges of each of the cube corners is substantially aligned with one of the diagonal lines.

29. The retroreflective article of claim 24, wherein the plurality of cube corners comprises a plurality of alternating obtuse angle and acute angle rhombus cube corners, wherein one of the exterior sides of each of the acute angle rhombus cube corners intersects the shared exterior side at a first end to form an acute angle and one of the exterior sides of each of the obtuse angle rhombus cube corners intersects the shared exterior side at the first end to form an obtuse angle.

30. The retroreflective article of claim 29 wherein:
each of the obtuse angles is within a range of about 90 degrees to about 120 degrees and each of the acute angles is within a range of about 90 degrees to about 60 degrees;
each of the obtuse angles are substantially the same;
each of the acute angles are substantially the same; and
the sum of one of the obtuse angles and one of the acute angles is substantially equal to 180 degrees.

31. The retroreflective article as set forth in claim 29 wherein the at least one shared exterior side is intersected at two points spaced apart by the respective one of the interior edges of each of the adjacent rhombus cube corners.
